(19) United States
(12) Patent Application Publication
(10) Pub. No.: US 2026/0121202 A1
(43) Pub. Date: Apr. 30, 2026

(54) FASTENING STRUCTURE OF BATTERY PACK

(71) Applicant: TOYOTA JIDOSHA KABUSHIKI KAISHA, Toyota-shi (JP)

(72) Inventors: Yo YAMAMOTO, Nagoya-shi (JP); Takayuki SUGIYAMA, Toyota-shi (JP); Kota ICHISAWA, Toyota-shi (JP); Fumiaki AIKAWA, Anjo-shi (JP)

(73) Assignee: TOYOTA JIDOSHA KABUSHIKI KAISHA, Toyota-shi (JP)

(21) Appl. No.: 19/350,216

(22) Filed: Oct. 6, 2025

(30) Foreign Application Priority Data
Oct. 25, 2024 (JP) 2024-188633

(51) Int. Cl. H01M 50/264; B60K 1/04; H01M 10/625; H01M 10/653; H01M 10/6554; H01M 50/242; H01M 50/249

(52) U.S. Cl. CPC H01M 50/264; B60K 1/04; H01M 10/625; H01M 10/653; H01M 10/6554; H01M 50/242; H01M 50/249; B60K 2001/0438; H01M 2220/20

(57) ABSTRACT

A fastening structure of a battery pack includes a floor cross member extending in a vehicle width direction; a battery pack including one or more battery modules, and a battery case accommodating the one or more battery modules, the battery pack being disposed below the floor cross member; and a plurality of fastening brackets fixed to a top surface of the battery case and fastened to the floor cross member, in which at least one of the fastening brackets includes a spring-shaped portion that is extendable and contractible in an up-down direction.

### CROSS-REFERENCE TO RELATED APPLICATION

This application claims priority to Japanese Patent Application No. 2024-188633 filed on Oct. 25, 2024. The disclosure of the above-identified application, including the specification, drawings, and claims, is incorporated by reference herein in its entirety.

### BACKGROUND

### 1. Technical Field

The present specification discloses a fastening structure for fastening a battery pack to a frame member of a vehicle.

### 2. Description of Related Art

In recent years, an electrified vehicle equipped with a motor as a traveling power source is widely known. The electrified vehicle includes a battery pack that charges and discharges electric power. A configuration in which the battery pack is disposed under a floor of a vehicle cabin has been partially proposed.

For example, Japanese Unexamined Patent Application Publication No. 2020-136072 (JP 2020-136072 A) discloses a battery pack mounted on a lower side of a floor panel of a vehicle. In this case, the battery pack has a cross frame extending in a vehicle width direction. Both ends of the cross frame in the vehicle width direction are connected to a rear side member of the vehicle through a member called a post.

### SUMMARY

However, in the technique of JP 2020-136072 A, the battery pack is fastened to the frame member of the vehicle solely at both ends in the vehicle width direction. In other words, a center member of the battery pack in the vehicle width direction is not fastened to the frame member. Therefore, in the technique of JP 2020-136072 A, there is a problem that a load on the post positioned at both ends in the vehicle width direction is large.

Therefore, it is conceivable to fasten not solely end portions of the battery pack in the vehicle width direction but also a center portion of the battery pack in the vehicle width direction to the frame member of the vehicle. For example, a configuration in which both ends of the battery pack in the vehicle width direction are fastened to side members and a center of the battery pack in the vehicle width direction is fastened to a cross member is conceivable. In a case where the battery pack is configured as described above, the battery pack is bent by its own weight at a time when both ends of the battery pack in the vehicle width direction are fastened. The bend is corrected when the battery pack is fastened to the cross member at the center of the battery pack in the vehicle width direction. With the correction, a stress is applied to a part of components of the battery pack (for example, a battery module or a heat conductive member).

That is, in a case where, in addition to both ends of the battery pack in the vehicle width direction, the center of the battery pack in the vehicle width direction is further fastened to the frame member of the vehicle, a load on the fastening member can be reduced, but a load on the battery pack may increase.

Therefore, the present specification discloses a fastening structure of a battery pack, the fastening structure being able to reduce the load on the battery pack.

A fastening structure of a battery pack disclosed in the present specification includes a cross member extending in a vehicle width direction, a battery pack including one or more battery modules, and a battery case accommodating the one or more battery modules, the battery pack being disposed below the cross member, and a plurality of fastening brackets fixed to a top surface of the battery case and fastened to the cross member, in which at least one of the fastening brackets includes a spring-shaped portion that is extendable and contractible in an up-down direction.

Since the fastening bracket has the spring-shaped portion, excessive upward pulling of the top surface of the battery case is restrained. As a result, deformation or the like of the battery module is restrained.

In this case, the spring-shaped portion may have a corrugated shape in which a plate material is folded and overlapped in the up-down direction.

With such a configuration, the bracket having the spring-shaped portion can be easily formed by press molding or the like.

In addition, at least one of the fastening brackets may be disposed in a posture in which a crease of the spring-shaped portion is substantially parallel to the vehicle width direction.

With such a configuration, a section modulus viewed from a side of the vehicle increases, and resistance to a side collision is improved.

In addition, the fastening brackets may include
a first fastening bracket disposed in a vicinity of an end portion of the battery pack in the vehicle width direction, and
a second fastening bracket disposed on a center side in the vehicle width direction relative to the first fastening bracket,
the first fastening bracket may be disposed in a posture in which the crease of the spring-shaped portion is substantially parallel to a front-rear direction, and
the second fastening bracket may be disposed in a posture in which the crease of the spring-shaped portion is substantially parallel to the vehicle width direction.

By disposing the second fastening bracket having the crease substantially parallel to the vehicle width direction at the center of the battery pack in the vehicle width direction where a rigidity is likely to be reduced, the resistance to the side collision is improved. In addition, by changing a direction of the crease of the fastening bracket depending on a position, a variation in the rigidity depending on the position can be reduced. As a result, resistance to input loads from various directions is enhanced.

The fastening structure further includes a pair of side members extending in a vehicle front-rear direction, in which right and left ends of the battery case may be fastened to the side members, respectively, and the battery pack may include a heat conductive member disposed between a top surface of each of the one or more battery modules and the top surface of the battery case and adhered to both of the top surfaces.

By providing the heat conductive member, heat generated in the battery module can be effectively dissipated. In addition, by providing the fastening bracket having the spring-shaped portion, the heat conductive member is restrained from being peeled off.

According to the technique disclosed in the present specification, the load on the battery pack can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery pack;

FIG. 2 is a cross-sectional view taken along a line II-II in FIG. 3;

FIG. 3 is a cross-sectional view of the battery pack and the frame member;

FIG. 4 is a perspective view of a fastening bracket;

FIG. 5 is a cross-sectional view of another fastening bracket;

FIG. 6 is a cross-sectional view of another fastening bracket;

FIG. 7 is a plan view showing another arrangement of fastening brackets;

FIG. 8 is a diagram showing a process of fastening the battery pack in a case where the fastening bracket does not have a spring-shaped portion; and

FIG. 9 is a diagram showing a process of fastening the battery pack in a case where the fastening bracket does not have a spring-shaped portion.

### DETAILED DESCRIPTION OF EMBODIMENTS

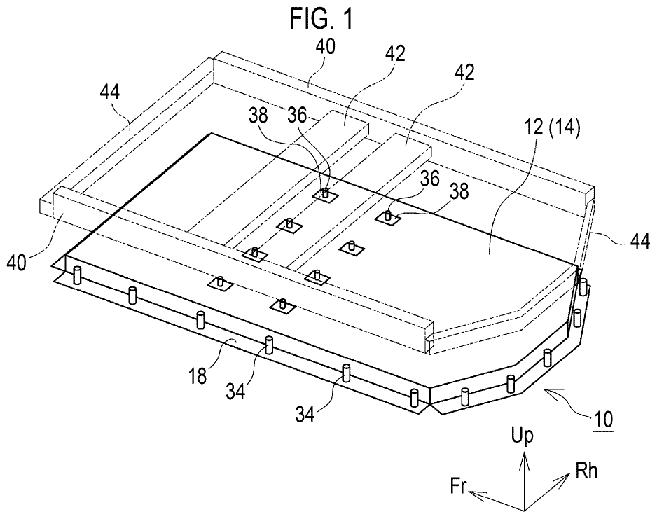

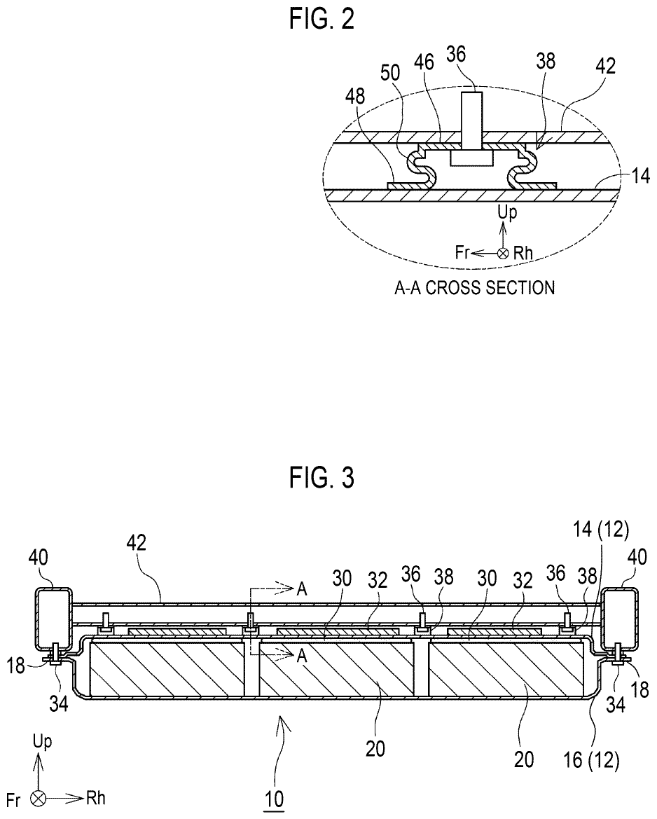

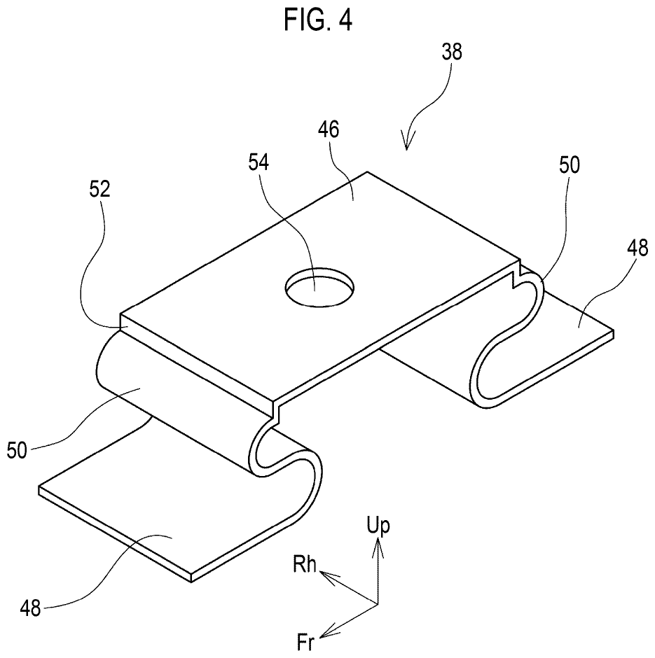

Hereinafter, a fastening structure of a battery pack 10 will be described with reference to drawings. FIG. 1 is a schematic perspective view of the battery pack 10. In addition, FIGS. 2 and 3 are cross-sectional views of the battery pack 10 and a frame member, and FIG. 4 is a perspective view of a fastening bracket 38 to be described later. In addition, Fr, Up, and Rh in each of the drawings indicate the front, the upper side, and the right side of a vehicle, respectively.

The battery pack 10 is mounted on an electrified vehicle having a motor (not shown) as a power source. The electrified vehicle is not particularly limited as long as the battery pack 10 is mounted. Therefore, the electrified vehicle may be, for example, a hybrid battery electric vehicle equipped with a motor and an internal combustion engine. The electrified vehicle may be, for example, a plug-in hybrid battery electric vehicle that can be externally charged or a battery electric vehicle that travels solely by the power of a motor.

The battery pack 10 stores traveling electric power, and the motor is driven by electric power supplied from the battery pack 10. In addition, the battery pack 10 has a flat shape having a plane size significantly larger than its thickness. The battery pack 10 is disposed under a floor of a vehicle cabin.

A pair of side members 40 is disposed under the floor of the vehicle cabin. Each side member 40 is a long frame member in the vehicle front-rear direction. Each side member 40 has a hollow and a cross section having a substantially rectangular shape, and is formed by, for example, extrusion molding. Two of the side members 40 are disposed apart from each other in the vehicle width direction. The disposition interval between two of the side members 40 is substantially the same as the vehicle width direction dimension of the vehicle cabin. Two of the side members 40 are connected by a plurality of cross members 42, 44. The cross members 42, 44 are long frame members in the vehicle width direction. Each of the cross members 42, 44 has a hollow and substantially rectangular cross section, and is formed by, for example, extrusion molding, similarly to the side members 40. Hereinafter, among the cross members 42, 44, a cross member 42 that connects the vicinity of the center of the side members 40 in the vehicle front-rear direction is referred to as a “floor cross member 42”.

The battery pack 10 is disposed below the side members 40 and the cross members 42, 44 described above and is fastened to the side members 40 and the cross members 42, 44. The configuration of the fastening will be described in detail later. As shown in FIG. 3, the battery pack 10 includes a battery case 12, a battery module 20, a heat conductive member 30, and a heat sink 32. The battery case 12 is configured by an upper cover 14 and a lower case 16. The lower case 16 is a member having a substantial box shape accommodating a plurality of the battery modules 20. The upper cover 14 is a cover covering an upper end opening of the lower case 16 from the upper side. Both the lower case 16 and the upper cover 14 have a flange 18 protruding outward in a horizontal direction from the respective peripheries. A plurality of end portion fastening bolts 34 protruding upward are welded to the flange 18.

In addition, among the upper cover 14, a plurality of fastening brackets 38 are welded at intervals in the vehicle width direction to a portion of the upper cover 14 immediately below the floor cross member 42. Further, a fastening bolt 36 protruding upward is welded to the fastening bracket 38. The battery case 12 is screwed and fastened to the side member 40, the cross member 44, and the floor cross member 42 via the end portion fastening bolts 34 and a plurality of the fastening bolts 36. Here, as shown in FIGS. 2, 3, and 4, the fastening bracket 38 has a corrugated portion in which a plate material is vertically folded and overlapped. A specific configuration of the fastening bracket 38 will be described below.

The battery module 20 is a module in which a plurality of battery cells is electrically connected in series or in parallel. The battery cell is a chargeable and dischargeable secondary battery. Inside the battery case 12, the battery modules 20 are arranged in a two-dimensional array. In the example of FIG. 3, inside the battery case 12, the battery modules 20 are disposed in three columns in the vehicle width direction. Each battery module 20 is fixed to the lower case 16 via a fixing member (not shown).

The heat conductive member 30 is disposed between the top surface of the battery module 20 and the upper cover 14. The heat conductive member 30 is a member having a sheet shape made of a material having a high thermal conductivity. The heat conductive member 30 may be a metal, such as aluminum, or a thermally conductive sheet called a thermal sheet. The thermal sheet is a sheet made of a resin (for example, silicone or acrylic) containing a metal filler having a high thermal conductivity. A lower surface of the heat conductive member 30 is adhered to a top surface of the battery module 20, and an upper surface of the heat conductive member 30 is adhered to the upper cover 14.

The heat sink 32 is disposed on the opposite side of the heat conductive member 30 with the upper cover 14 interposed therebetween. In addition, in FIG. 1, the illustration of the heat sink 32 is omitted. The heat sink 32 is a member that releases the heat transmitted from the battery module 20 to the outside air through the heat conductive member 30. The heat sink 32 is made of a metal having a high thermal conductivity, for example, aluminum. The heat sink 32 is adhered or welded to an upper surface of the upper cover 14. In FIG. 3, the heat sink 32 is shown as a simple rectangle. However, in practice, the heat sink 32 is provided with a large number of protrusions and recesses in order to increase the surface area of the heat sink 32, and thus the contact area with air. In the present example, a plurality of the heat sinks 32 are arranged at intervals in the vehicle width direction.

By providing the heat sink 32 and the heat conductive member 30, the heat generated in the battery module 20 is efficiently dissipated to the outside. As a result, the battery module 20 is restrained from being excessively high in temperature, and thus the deterioration or damage of the battery module 20 due to heat can be effectively suppressed.

Next, a configuration of the fastening bracket 38 for fastening the battery pack 10 to the floor cross member 42 will be described. As described above, the fastening bracket 38 is made of metal and is welded to the upper cover 14 directly under the floor cross member 42.

As shown in FIGS. 2, 3, and 4, the fastening bracket 38 has a shape in which both sides of a plate material having a strip shape are bent into a substantially S shape. More specifically, the fastening bracket 38 has a frame fastening portion 46, a pair of cover coupling portions 48, a pair of spring-shaped portions 50, and a pair of upright walls 52. The frame fastening portion 46 is a portion to which the fastening bolt 36 is welded. A fastening hole 54 is provided in the center of the frame fastening portion 46. A shaft portion of the fastening bolt 36 is disposed in the fastening hole 54, and a head portion of the fastening bolt 36 is welded to a back surface of the frame fastening portion 46.

The upright wall 52 extending vertically downward is connected to each of both sides of the frame fastening portion 46. Further, the spring-shaped portion 50 is connected to a lower end of each upright wall 52. As shown in FIG. 4, the spring-shaped portion 50 is a substantially S-shaped portion that extends from the lower end of the upright wall 52 to the outside in a longitudinal direction, is folded toward the inside in the longitudinal direction, and is further folded toward the outside in the longitudinal direction. In other words, the spring-shaped portion 50 has a substantially corrugated shape in which a plate material is folded and overlapped in the up-down direction. The spring-shaped portion 50 functions as a plate spring that is extendable and contractible in the up-down direction.

The cover coupling portion 48 is connected to a lower end of the spring-shaped portion 50. The cover coupling portion 48 is a portion having a flat plate shape extending from the lower end of the spring-shaped portion 50 to the outside in the longitudinal direction. The cover coupling portion 48 is welded to the top surface of the upper cover 14.

The fastening bracket 38 is disposed directly under the floor cross member 42 and at a position that does not interfere with the heat sink 32. In addition, the fastening bracket 38 is disposed in a posture in which the crease of the spring-shaped portion 50 is parallel to the vehicle width direction. With such a configuration, a section modulus of the fastening bracket 38 when viewed from a side of the vehicle increases. As a result, a side collision occurs, and even when a load directed inward in the vehicle width direction is input, the deformation of the fastening bracket 38 is less likely to occur, and the fastening state between the battery pack 10 and the floor cross member 42 is easily maintained.

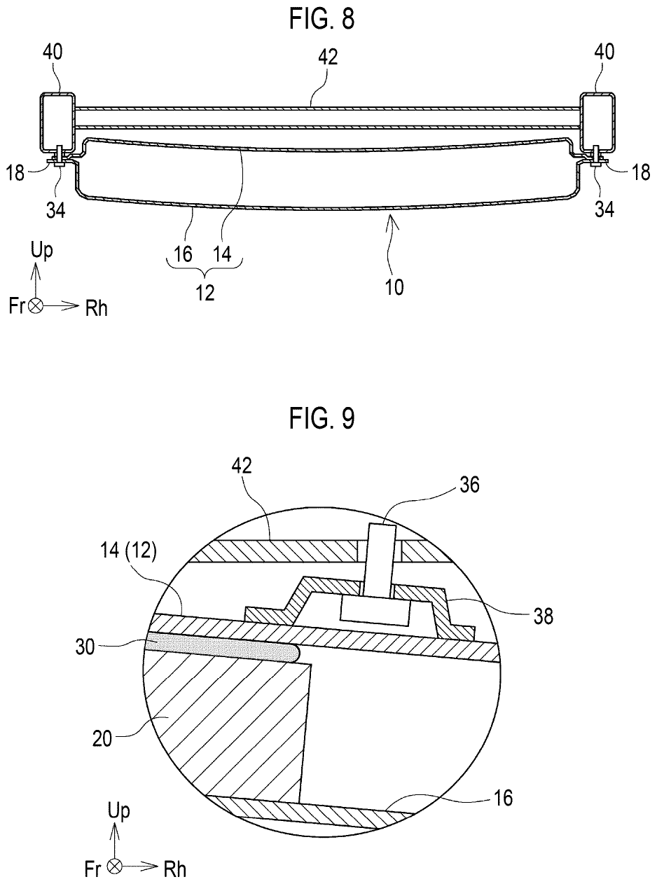

As described above, the fastening bracket 38 of the present example has the spring-shaped portion 50 that is extendable and contractible in the up-down direction. The reason for such a configuration will be described. FIG. 8 is a schematic diagram showing a process of fastening the battery pack 10 to a frame member of a vehicle.

In a case where the battery pack 10 is attached to a frame member of a vehicle, generally, the flange 18 of the battery pack 10 is first fastened to the side member 40, and then the center portion of the battery pack 10 is fastened to the floor cross member 42. Therefore, in the process of attaching the battery pack 10, as shown in FIG. 8, a state in which solely the end portion of the battery pack 10 is fastened to the frame member occurs.

Here, since the battery pack 10 is a large and heavy component, when solely the end portion is fastened, as shown in FIG. 8, the battery pack 10 is bent to be convex to the lower side of the vehicle due to the weight of the battery pack 10. FIG. 9 is a schematic cross-sectional view of the battery pack 10 when the center of the battery pack 10 in the vehicle width direction is bent downward. In this case, the top surface of the battery pack 10 is significantly separated from the bottom surface of the floor cross member 42. In this state, when the fastening bracket 38 does not have the spring-shaped portion 50, the upper cover 14 is strongly pulled upward when the fastening bolt 36 is fastened to the floor cross member 42. In addition, in a case where the upper cover 14 is pulled upward, there is a possibility that the heat conductive member 30 is peeled off from the upper cover 14 or the battery module 20, or the battery module 20 is deformed due to stress.

In the present example, the spring-shaped portion 50 is provided in the fastening bracket 38 in order to restrain the deterioration and damage of the heat conductive member 30 and the battery module 20. In a case where the above configuration is applied, even in a case where the fastening bolt 36 is pulled upward to fasten the fastening bolt 36 to the floor cross member 42, the pulling force is absorbed by the deformation of the spring-shaped portion 50 and is not transmitted to the upper cover 14. As a result, an excessive load on the upper cover 14 is effectively restrained from being applied in association with the fastening of the fastening bolt 36. As a result, the peeling of the heat conductive member 30 and the deformation of the battery module 20 are effectively restrained.

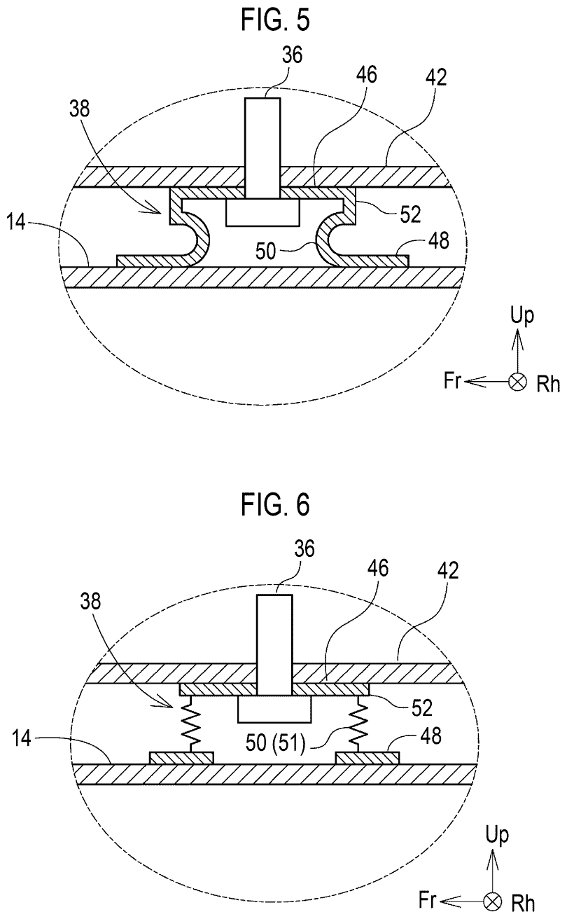

As is clear from the above description, the fastening bracket 38 of the present example is configured to provide the spring-shaped portion 50 by folding a part of the fastening bracket 38 in an S-shape. With such a configuration, the fastening bracket 38 that is extendable and contractible up and down can be easily manufactured. For example, such a fastening bracket 38 can be easily manufactured by press molding. As a result, the manufacturing cost of the component can be reduced. Such a configuration is an example, and the spring-shaped portion 50 may have another configuration. For example, as shown in FIG. 5, the spring-shaped portion 50 may have a C-shape in which the spring-shaped portion 50 is folded once, instead of an S-shape in which the spring-shaped portion 50 is folded twice. Further, as another aspect, as shown in FIG. 6, the spring-shaped portion 50 of the fastening bracket 38 may be a coil spring 51 interposed between the frame fastening portion 46 and the cover coupling portion 48.

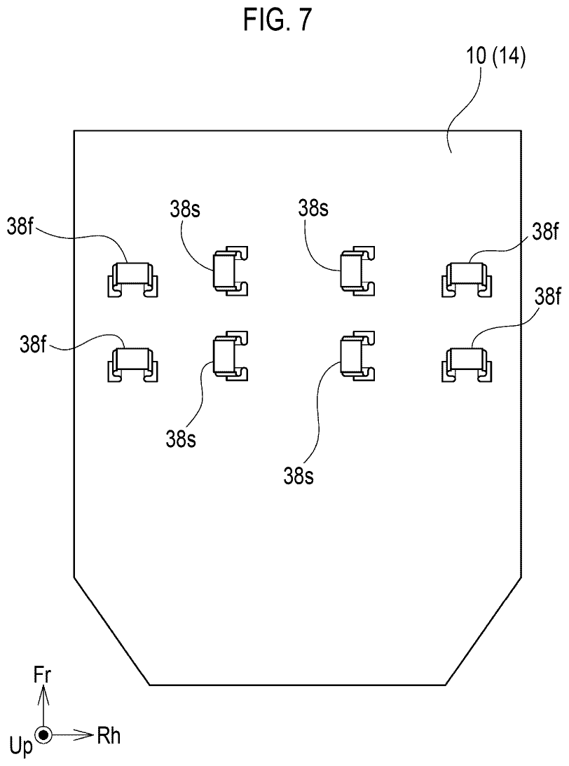

In addition, in the above description, the fastening bracket 38 is disposed in a posture in which the crease of the spring-shaped portion 50 is parallel to the vehicle width direction. However, the posture of the disposition of the fastening bracket 38 may be appropriately changed. For example, each of the fastening brackets 38 may be disposed in a posture in which the crease is parallel to the vehicle front-rear direction. Further, as another aspect, some of the fastening brackets 38 may be disposed in different postures from each other. For example, as shown in FIG. 7, first fastening brackets 38f and second fastening brackets 38s may be provided, the first fastening brackets 38f being positioned near an end portion of the battery pack 10 in a vehicle width direction, and the second fastening brackets 38s being positioned on a center side of the battery pack 10 relative to the first fastening brackets 38f in the vehicle width direction. The first fastening brackets 38f may be disposed with the crease parallel to the vehicle front-rear direction, and the second fastening brackets 38s may be disposed with the crease parallel to the vehicle width direction. By disposing the second fastening brackets 38s in the center portion in the vehicle width direction where the rigidity is likely to decrease, resistance to the side collision is improved. In addition, by changing the direction of the crease of the fastening brackets 38f, 38s depending on the location, the variation in rigidity for each location can be reduced, and the fastening brackets 38f. 38s can be made strong against forces in various directions. In addition, the battery pack 10 of the present example includes the heat conductive member 30 and the heat sink 32, but the presence or absence and the position of the heat conductive member 30 and the heat sink 32 may be appropriately changed.

What is claimed is:

1. A fastening structure of a battery pack, the fastening structure comprising:
a cross member extending in a vehicle width direction;
a battery pack including one or more battery modules, and a battery case accommodating the one or more battery modules, the battery pack being disposed below the cross member; and
a plurality of fastening brackets fixed to a top surface of the battery case and fastened to the cross member,
wherein at least one of the fastening brackets includes a spring-shaped portion that is extendable and contractible in an up-down direction.

2. The fastening structure according to claim 1, wherein the spring-shaped portion has a corrugated shape in which a plate material is folded and overlapped in the up-down direction.

3. The fastening structure according to claim 2, wherein at least one of the fastening brackets is disposed in a posture in which a crease of the spring-shaped portion is substantially parallel to the vehicle width direction.

4. The fastening structure according to claim 3, wherein:
the fastening brackets include
a first fastening bracket disposed in a vicinity of an end portion of the battery pack in the vehicle width direction, and
a second fastening bracket disposed on a center side in the vehicle width direction relative to the first fastening bracket;
the first fastening bracket is disposed in a posture in which the crease of the spring-shaped portion is substantially parallel to a front-rear direction; and
the second fastening bracket is disposed in a posture in which the crease of the spring-shaped portion is substantially parallel to the vehicle width direction.

5. The fastening structure according to claim 1, further comprising a pair of side members extending in a vehicle front-rear direction, wherein:
right and left ends of the battery case are fastened to the side members, respectively; and
the battery pack includes a heat conductive member disposed between a top surface of each of the one or more battery modules and the top surface of the battery case and adhered to both of the top surfaces.
